(19) United States
(12) Patent Application Publication
(10) Pub. No.: US 2012/0275468 A1
(43) Pub. Date: Nov. 1, 2012

(54) METHOD FOR TRANSMISSION OF LAYERED MULTIMEDIA CONTENTS TO HETEROGENEOUS TERMINALS VIA A TDM/TDMA MULTIPLEXING INFRASTRUCTURE, AND ASSOCIATED PROCESSING DEVICE AND DECODER

(76) Inventors: Yann Leprovost, Nozay (FR); Bessem Sayadi, Nozay (FR); Marie Line Alberi-Morel, Nozay (FR)

(21) Appl. No.: 12/672,830

(22) PCT Filed: Jul. 24, 2008
(86) PCT No.: PCT/EP2008/059751

§ 371 Date: Feb. 28, 2011

(30) Foreign Application Priority Data
Aug. 9, 2007 (FR) 0757016

(51) Int. Cl. H04J 3/00

(52) U.S. Cl. 370/442

(57) ABSTRACT

A transmission device (ET) is intended to be a component of a time multiplexing (RC) transmission infrastructure with at least one channel and in different transmission time slots, of multimedia contents, such multimedia contents being arranged in at least two complementary data layers. Said device (D) is responsible, in the presence of an association of a time slot to each complementary layer constituting a channel multimedia content, i) for separating the complementary layers of each multimedia content to be transmitted, ii) for chopping up the separated complementary layers into portions of selected sizes, and iii) for incorporating each portion of a layer into a burst so as to transmit each burst during a time slot associated to the layer comprising the portion it integrates.

The invention concerns the transmission of so-called “layered” multimedia contents by means of time multiplexing transmission infrastructures.

In this context, “layered multimedia contents” means a set of data arranged in at least two complementary layers, such as for example a so-called base layer and at least one so-called enhancement layer. The base layer comprises all data of a multimedia content that will enable a communication terminal to reproduce said multimedia content with the lowest level of quality (or definition or resolution). Each enhancement layer comprises another dataset of said multimedia content that will enable said communication terminal to complete the entire set of data of the base layer in order to reproduce the multimedia content at an improved level of quality (or definition or resolution). It will be understood that the n-th enhancement layer of a multimedia content can only be used on condition that the base layer and the n-1 preceding enhancement layers of said multimedia content (associated to lower levels of quality (or definition or resolution)) have already been received. A layered multimedia content may for example be a television or radio programme, an audio file or a video.

Furthermore, in the present context, “time multiplexing transmission infrastructure” (or, in short, “TDM/TDMA infrastructure”), shall mean any infrastructure in which the transmission of multimedia contents takes place monodirectionally or bidirectionally by means of TDM/TDMA type time multiplexing (Time Division Multiplexing/Time Division Multiple Access). Therefore, the network in question may be either a communication or a broadcasting network.

It is hereby reiterated that TDM multiplexing consists in time multiplexing of services, and that therefore several users can access one and the same service at the same time, while TDMA multiplexing consists in time multiplexing of contents intended for different users, where each content may correspond to one or more services.

Furthermore, in the present context “broadcasting network” shall mean any type of terrestrial and/or satellite infrastructure capable of transmitting multimedia contents according to a monodirectional (one way) downlink to communication terminals.

Besides, in the present context “communication network” shall mean all types of bidirectional communication infrastructure, whether broadband, wired or wireless, capable in particular of broadcasting multimedia contents to terminals in “broadcast” and/or “multicast” (point to multipoints) and/or “unicast” (point to point) mode.

Therefore, a TDM/TDMA infrastructure may be a wired network, e.g. of xDSL, fibre or cable type, or a wireless network such as a TDM multiplexing broadcast network (e.g. a terrestrial DVB-H type network (for Digital Video Broadcasting—Handhelds—mobile television)), or a multiplexing TDM satellite network (e.g. of DVB-S2 type) or of TDMA type (e.g. of DVB-RCS type), or a TDM type hybrid multiplexing network, i.e. both satellite and terrestrial (such as a DVB-SH type network (satellite links with terrestrial links))), or a cellular (or mobile) TDMA type multiplexing network (e.g. a GSM/EDGE, WiMAX type network (in the single carrier and multicarrier modulation modes), or Wi-Fi).

Finally, in the present context the term “communication terminal” refers to any fixed or mobile (or portable or cellular) communication device capable at least of receiving layered multimedia contents from a (possibly wave transmitted) TDM/TDMA type multimedia content transmission infrastructure. Consequently, it may, for example, be a fixed or mobile (or cellular) telephone, a laptop or desktop computer, a personal digital assistant (or PDA), a layered multimedia content receiver (for example, a decoder, a residential gateway, or a set-top box (STB), as long as it is equipped with potentially radio-based or satellite-based communication means suitable for the reception of layered multimedia contents.

As is known by persons skilled in the art, in TDM/TDMA type transmission infrastructures, different transmission time slots are generally assigned to such different multimedia content channels or to different IP streams. A given channel's multimedia contents (or those of a given IP stream) are then decomposed into portions that are placed into bursts transmitted via the infrastructure during time slots attributed to that channel (or to that IP stream). In this context, a channel shall be a TV or radio station or channel or a video broadcaster.

When the user of a (communication) terminal wishes to receive the multimedia contents of a given channel (or IP stream), he/she will select the appropriate channel with his/her terminal, and will only activate his/her receiver during the time slots attributed to the chosen channel. During the time slots attributed to the other, not chosen, channels, the receiver is placed in idle mode, thus enabling savings in processing capacity (or CPU) and in energy (which is advantageous in the case of a battery equipped mobile or portable terminal).

In the current TDM/TDMA infrastructures, each burst contains a portion of encoded data from all the supplementary layers of a layer encoded multimedia content. In other words, a burst represents a portion of a multimedia content at the best level of quality (or definition or resolution). Therefore, when a user has selected a channel, his/her terminal must decode all data contained in the bursts of the chosen channel in order to reconstitute all layers of the transmitted multimedia content, and then it will communicate to its player the layer(s) the latter can use taking into account the characteristics of the user's terminal.

It will be understood that this operating mode is highly suitable for terminals fitted with players capable of reproducing multimedia contents at the highest level of quality (or definition or resolution). On the other hand, this operating mode is not appropriate for terminals fitted with players capable of reproducing multimedia contents at an intermediate or lowest level of quality (or definition or resolution), since they must reconstitute layers that are not usable by their players and which therefore waste processing capacity and energy.

In other words, the current operating mode is not very suitable for the infrastructures to which heterogeneous terminals may connect (i.e. presenting different technical characteristics such as decoding capabilities, screen resolutions, or memory capabilities).

The purpose of the invention is therefore to improve the situation.

The invention therefore proposes a method dedicated to transmission, via a time multiplexing transmission infrastructure of multimedia contents with at least one channel, and adapted for transmission in transmission time slots, such multimedia contents being arranged in at least two complementary data layers, wherein a time slot is associated to each complementary layer constituting a multimedia content of a channel (or multimedia flow), so as to transmit portions of such complementary multimedia content layers during the time slots respectively associated with them.

It is to be noted that the time slots associated to a channel (and more precisely to its different complementary content layers) are not necessarily contiguous. The different complementary layers of the different channels can in fact be interleaved. Moreover, the transmission period of the bursts (containing the layer portions) is not necessarily the same for all complementary layers and for all channels.

The method of the invention may comprise other characteristics, which may be taken separately or in combination, in particular:
it is possible to separate the complementary layers of each multimedia content to be transmitted, then to divide the separated complementary layers into portions of a selected size, and finally to incorporate each portion of a layer within a burst in order to transmit each burst during a time slot associated to the layer comprising the portion it integrates;
it is possible to transmit to communication terminals (receivers of multimedia content) signalling messages containing information that is representative of the temporal positions of the time slots and their association to the different complementary layers;
the complementary layers may for example comprise a basic layer and at least one enhancement layer.

The invention also proposes a processing device for a time multiplexing layered multimedia content transmission infrastructure of at least one channel in transmission time slots, responsible, in the presence of the association of a time slot to each complementary layer constituting a multimedia channel content:
for separating the complementary layers of each multimedia content for transmission,
for dividing the separate complementary layers into portions of a selected size, and
for incorporating each portion of a layer into a burst so that each burst is transmitted during a time slot associated to the layer comprising the portion it integrates.

The invention also proposes transmission equipment for a time multiplexing layered multimedia content transmission infrastructure of at least one channel in transmission time slots, and comprising a processing device as described above.

The invention also proposes a communication terminal suitable for connection to a time multiplexed transmission infrastructure and comprising a receiver, a player, suitable for the utilisation of at least one complementary data layer chosen from multimedia contents in layers of at least one channel, and a decoder responsible for decoding portions of layered multimedia contents received by the receiver in order to feed the player with chosen complementary layers.

Said terminal decoder comprises:
activation means responsible, in the case of selection of a channel and in the presence of an association of a time slot to each complementary layer constituting a channel multimedia content, for activating the receiver during each time slot associated to each supplementary layer of a content of the selected channel and capable of being used by the player, and
processing means responsible for reconstituting each multimedia content layer capable of being used by the player based on the portions received by the receiver when it is activated and as a function of the time slots during which the portions were transmitted.

The invention is particularly suitable, although not exclusively so, for networks of the DVB-H, DVB-SH and WiMAX types.

Other characteristics and advantages of the invention will become apparent upon examining the detailed description below and the attached drawings, wherein:

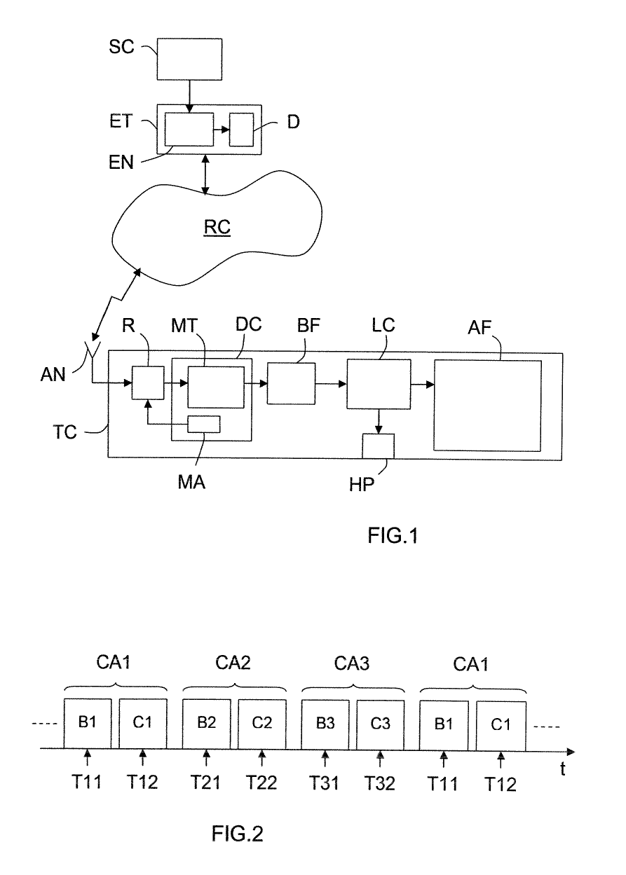

FIG. 1 highly schematically and functionally depicts a TDM transmission infrastructure to which are connected an embodiment of a communication terminal according to the invention and transmission equipment fitted with a processing device according to the invention, and

FIG. 2 is a time diagram (t) representing an example of the subdivision of time slots (associated to three different channels) into two sub-slots each (associated to two different layers).

The attached drawings may serve not only to complete the invention, but also to contribute to its definition as necessary.

The purpose of the invention is to propose a transmission mode for layered multimedia contents via a TDM/TDMA multiplexing transmission infrastructure suitable for heterogeneous terminals.

Hereafter, it shall be considered for the sake of example but not of limitation that the transmission infrastructure is a DVB-H (Digital Video Broadcasting—Handhelds—mobile television) type TDM multiplexing radio communication network. However, the invention is not limited to this type of transmission infrastructure. In fact, it concerns all types of infrastructure able to ensure monodirectional or bidirectional transmission of multimedia contents by means of TDM or TDMA time multiplexing, in either a monodirectional (terrestrial and/or satellite) broadcasting network or in a bidirectional broadband, wired or wireless communication network. Consequently, it may be also be a wired network, such as an xDSL, fibre, or cable network; or a cellular (or mobile) GSM/EDGE type network, a terrestrial network implementing a technology arising out of a satellite technology (for example, DVB-S, DVB-S2 or DVB-RCS); or a hybrid network, such as a DVB-SH type network

Furthermore, it is assumed in what follows, by way of example and not of limitation, that the communication terminals are mobile (or cellular) telephones or personal digital assistants (PDAs). However, the invention is not limited to this type of communication terminal. In fact, it concerns any fixed or mobile (or portable or cellular) communication device capable at least of receiving layered multimedia contents from a (possibly wave transmitted) TDM/TDMA type transmission infrastructure. Consequently, it may also be a fixed or mobile (or cellular) telephone, a laptop or desktop computer, a personal digital assistant (PDA), a layered multimedia content receiver (for example, a decoder, a residential gateway, or a set-top box (STB)), as long as it is equipped with potentially radio-based or satellite-based communication means suitable at least for the reception of layered multimedia contents.

Furthermore, it is assumed in the following discussion by way of example but not of limitation that the layered multimedia contents broadcast to the terminals are videos. However, the invention is not limited to this type of layered multimedia content. In fact, it concerns all types of layered multimedia contents, and more particularly radio or TV programmes or audio content.

As is schematically illustrated in FIG. 1, the implementation of the invention requires the presence of at least one layered multimedia content transmission device ET equipped with (or coupled to) a processing device D, of at least one (communication) terminal TC, and of at least one TDM or TDMA RC transmission infrastructure.

In the following discussion, it is considered by way of example and not of limitation that the multimedia contents (in this case, videos) are arranged in two complementary layers, one being a base layer and the other being an enhancement layer intended to improve the level of quality (or definition or resolution) offered by the base layer when it is combined with the enhancement layer. However, the invention is not limited to this number (2) of complementary layers. Their number can in fact be as large as desired provided that it is equal to at least two (2).

The transmission equipment ET, for example, may be an access gateway responsible for generating video streams (potentially in the form of IP packets) based on layered multimedia contents and to supply such streams to the network RC. The layered multimedia contents may be of any origin. In FIG. 1, illustrated by way of example and not of limitation, the videos are supplied by a server (or a services platform) SC.

For example, the transmission equipment ET receives dual (complementary) layer videos Bi and Ci associated to three different channels CAi (i=1 to 3). However, the invention is not limited to this number of layers and channels. As indicated above, the number of complementary layers can in fact be as large as desired (within the limitation of the transmission capacity of the network RC). In addition, the invention applies as soon as contents of at least one channel must be transmitted (transported).

In the present context, the transmission equipment ET comprises (by way of example and not of limitation) an encoder EN responsible for encoding the data that define the videos and a processing device D coupled to the output of the encoder EN, to be addressed in greater detail at a later stage.

In order to be able to receive (and potentially transmit) layered multimedia content, the (communication) terminals TC comprise at least:
a burst receiver R (coupled to a potential aerial AN when it is of the radio type),
a decoder DC intended to decode the data contained in the bursts received by the receiver R in order to deliver data packets from complementary data layers constituting multimedia contents,
a buffer BF responsible for storing the packets delivered by the decoder DC until full reception of all packets constituting each of the desired complementary layers (corresponding to the capacity of the terminal TC), and then for delivering such stored packets to an output once their complementary layers have been fully reconstituted,
a content player LC responsible for using the complementary layer packets delivered by the buffer BF in order to display and/or broadcast the multimedia contents they constitute, and
a display AF, such as a screen, responsible for displaying the images of the multimedia contents delivered by the content player LC, and/or at least one loudspeaker HP, responsible for broadcasting the sounds of the multimedia contents delivered by the content player LC.

It should be noted that the buffer BF may potentially be part of the decoder DC.

The invention proposes the implementation of a new method for the transmission of layered multimedia contents (in this case, videos).

Said new method consists in associating a time slot Tij to each complementary layer (Bi, Ci) constituting a multimedia content of a channel CAi (or multimedia stream), in order to transmit portions of such complementary multimedia content layers during the time slots Tij respectively associated with them.

Thus, Ni time slots Tij are attributed to each channel CAi, where Ni is the number of complementary layers Bi and Ci constituting the multimedia contents of a channel CAi. It will be understood that the number Ni of complementary layers may potentially vary from one channel to another, but it can also be the same for all channels CAi.

The time diagram illustrated in FIG. 2 represents the complementary layer portions that are successively transmitted by the network RC in time slots Tij associated respectively to the complementary layers Bi and Ci of each of the three video channels CAi. In this case the index i, which designates a channel CAi, takes on values comprised between 1 and 3, and the index j, which designates the time slot Tij associated to a complementary layer Bi or Ci, takes on values comprised between 1 and 2. More specifically:
a portion of the base layer B1 of a video of the first channel CA1 is transmitted in a burst during the first time slot T11 of the first channel CA1,
a portion of the enhancement layer C1 of the same video of the first channel CA1 is transmitted in a burst during the second time slot T12 of the first channel CA1,
a portion of the base layer B2 of a video of the second channel CA2 is transmitted in a burst during the first time slot T21 of the second channel CA2,
a portion of the enhancement layer C2 of the same video of the second channel CA2 is transmitted in a burst during the second time slot T22 of the second channel CA2,
a portion of the base layer B3 of a video of the third channel CA3 is transmitted in a burst during the first time slot T31 of the third channel CA3,
a portion of the enhancement layer C3 of the same video of the third channel CA3 is transmitted in a burst during the second time slot T32 of the third channel CA3,
another portion of the base layer B1 of a video (potentially the same as that of the preceding portion) of the first channel CA1 is transmitted in a burst during another first time slot T11 of the first channel CA1,
another portion of the enhancement layer C1 of the same video of the first channel CA1 is transmitted in a burst during another second time slot T12 of the first channel CA1, and so forth.

It is important to note that the time slots associated to a channel Cai (and more precisely to its different complementary content layers) are not necessarily contiguous (as is the case in the time diagram shown by way of example but not of limitation in FIG. 2). The different complementary layers Bi and Ci of the different channels CAi can in fact be interleaved.

It is also important to note that the transmission period of the bursts containing the complementary layer portions (Bi and Ci) is not necessarily the same for all complementary layers Bi and Ci and for all channels CAi.

The method described above can be implemented by the abovementioned processing device D. To do so, said device D is designed so as, first of all, to separate the Ni supplementary layers (in this case, Bi and Ci) of each multimedia content (of each channel CAi) to be transmitted (delivered encoded by the encoder EN). It is also designed so as to chop the complementary layers it has separated out (in this case Bi and Ci) into portions of a selected size. Finally, it is designed so as to incorporate each portion of a layer (Bi or Ci) into a burst in order to transmit each burst during a time slot Tij associated to the Bi or Ci layer (of channel CAi) comprising the portion it integrates.

Because of the association of a time slot Tij to each complementary layer Bi or Ci, the communication terminals TC now merely need to reconstruct the layers (Bi and potentially Ci) they actually need (i.e. those they can actually use), taking into account their technical characteristics (e.g. the number of pixels of the screen AF and/or the decoding power), based on portions of the layers Bi or Ci they receive from the network RC in bursts during said time slots Tij with the same indices i and j.

To do so, transmission takes place to communication terminals TC via the network RC of signalling messages containing information that is representative of the temporal positions of the time slots Tij and their association to the different complementary layers Bi and Ci of the contents of the different channels CAi. For example, a signalling message may contain the starting time for a first slot T11, the duration of the time interval between the starts of the two successive time slots Tij and T(i+1)j or Ti(j+1), the number of time slots Tij and the relationship parameters between the time slots Tij and the associated complementary layers.

Such signalling messages are, for example, generated by a single processing device D. However, it could be envisaged that they would be generated by several processing devices D.

The decoder DC of each terminal TC (according to the invention) comprises an activation module MA responsible, as soon as a channel CAi has been selected, for activating the receiver R during the slots Tij (of the same index i and of the same index or indice(s) j) that were associated to the complementary layers (Bi and potentially Ci), of the contents of the selected channel CAi, which can be used by the player LC.

In this context, “activate” shall mean the fact of authorising the feed to and therefore the operation of the receiver R during a time interval at least equal to the duration of a time slot Tij.

To be able to effect such activations at specific times, the activation module MA must not only use the abovementioned information contained in the signalling messages received, but also be substantially synchronised in regard to a clock of the network RC. Such synchronisation may e.g. take place by means of periodic transmission to the terminals TC of a signalling message comprising a synchronisation information.

By way of example, and by reference to the illustration of FIG. 2, provided by way of example and not of limitation, if the second channel CA2 has been selected and the content player LC can only use the base layer B2 of the multimedia contents (as a result of the technical characteristics of its terminal TC), the activation module MA will activate the receiver R just before the start of each first time slot 121 of the second channel CA2 and deactivate the receiver R just after the end of each first time slot 121 of the second channel CA2. If the second channel CA2 has been selected and the content player LC can use both the base layer B2 and the enhancement layer 02 of the multimedia contents, the activation module MA will activate the receiver R just before the start of each first time slot 121 of the second channel CA2 and deactivate the receiver R just after the end of each second time slot T22 of the second channel CA2. The first example concerns e.g. a mobile telephone capable of decoding QCIF (Quarter Common Intermediate Format—176×144 pixels per image and 15 frames per second) format videos, while the second example concerns e.g. a PDA capable of decoding videos of CIF (Common Intermediate Format—352×288 pixels per image and 30 frames per second) type. These examples pertain to video streams compliant with the H264 SVC Standard wherein the base layer Bi transports data in the QCIF format at a rate of 15 frames per second and the enhancement layer Ci transports data in the CIF format at a rate of 30 frames per second and is designed to improve the video quality offered by the base layer Bi when their respective data are combined.

The decoder DC of each terminal TC (according to the invention) also comprises a processing module MT responsible for reconstituting the packets of each multimedia content layer Bi or Ci that can be used by the content player LC based on the portions contained in the bursts received by the receiver R each time the latter is activated by the activation module MA and as a function of the time slots Tij during which said portions have been transmitted (and therefore received).

By way of example, and by reference to the illustration of FIG. 2, provided by way of example and not of limitation, if the second channel CA2 has been selected and the content player LC can only use the base layer B2 of the multimedia contents, the processing module MT reconstitutes, for the content player LC, each base layer B2 of a video of the second channel CA2 based on the portions contained in the bursts received during one or more first time slot(s) T21 of the second channel CA2. If the second channel CA2 has been selected and the content player LC can use both the base layer B2 and the enhancement layer C2 of the multimedia contents, the processing module MT reconstitutes, for the content player LC, each base layer B2 of a video of the second channel CA2 based on the portions contained in the bursts received during one or more first time slot(s) 121 of the second channel CA2 and each enhancement layer C2 of the same video of the second channel CA2 based on the portions contained in the bursts received during one or more second time slot(s) 122 of the second channel CA2.

The processing device D according to the invention, and/or the decoder DC according to the invention (and in particular its activation module MA), may be implemented in the form of electronic circuits, software (or computing) modules, or a combination of circuits and software.

The invention is not limited to the embodiments of the processing device, transmission equipment, decoder and communication terminal described above merely by way of example; rather, it encompasses all variants that a person skilled in the art may envision within the framework of the claims set forth below.

1. Method for transmission, via a time multiplexing (RC) transmission infrastructure of multimedia contents for transmitting at least one channel and adapted for transmission in transmission time slots, such multimedia contents being arranged in at least two complementary data layers, wherein a time slot is associated to each complementary layer constituting a multimedia content of a channel, so as to transmit portions of such complementary multimedia content layers during the time slots respectively associated to them.

2. Method according to claim 1, wherein i) the complementary layers of each multimedia content to be transmitted are separated out, ii) the separated complementary layers are divided into portions of selected sizes, and) each portion of a layer is incorporated into a burst so as to transmit each burst during a time slot associated to the layer comprising the portion it integrates.

3. Method according to claim 1, wherein signalling messages containing information that is representative of the temporal positions of said time slots and their association to the different complementary layers are transmitted to communication terminals (TC), receivers of said multimedia contents.

4. Method according to claim 1, wherein said complementary layers comprise a so-called base layer and at least one so-called enhancement layer.

5. Processing device (D) for a time multiplexing (RC) transmission infrastructure of multimedia contents with at least one channel and adapted for transmission in transmission time slots, such multimedia contents being arranged in at least two complementary data layers, wherein such device is adapted, in the presence of an association of a time slot to each complementary layer constituting a multimedia content of a channel, i) for separating the complementary layers of each multimedia content to be transmitted, ii) for dividing the separated complimentary layers into portions of a selected size, and iii) for incorporating each portion of a layer in a burst so that each burst is transmitted during a time slot associated to the layer comprising the portion it integrates.

6. Device according to claim 5, wherein said complementary layers comprise a so-called base layer and at least one so-called enhancement layer.

7. Device according to claim 5 implemented in transmission equipment (ET) for a time multiplexing (RC) transmission infrastructure of multimedia contents, with at least one channel and adapted for transmission in transmission time slots, such multimedia contents being arranged in at least two complementary data layers.

8. Communication terminal (TC) comprising a receiver (R), a player (LC), suitable for using at least one complementary data layer selected from among multimedia contents in layers of at least one channel, and a decoder (DC) adapted for decoding portions of multimedia contents in layers received by said receiver (R) so as to feed said player (LC) with selected complementary layers, wherein said decoder (DC) comprises i) activation means (MA) adapted, in the event of selection of a channel, and in the presence of an association of a time slot to each complementary layer constituting a multimedia content of a channel, for activating the receiver during each time slot associated to each complementary layer of a content of the selected channel and usable by said player (LC), and ii) for processing means (MT) designed to reconstitute each layer of multimedia content usable by said player (LC) based on the portions received by said receiver (R) when it is activated and as a function of the time slots during which said portions were transmitted.
